(19) United States
(12) Patent Application Publication
(10) Pub. No.: US 2019/0009199 A1
(43) Pub. Date: Jan. 10, 2019

(54) YARN WITH MULTI-DIRECTIONAL LAYERED FIBERS

(71) Applicant: MAAGAN FILTRATION ACA LTD., Kibbutz Ma'agan Michael (IL)

(72) Inventors: Shirra GUR-REZNIK, Haifa (IL); Uria BERCHMAN, Kibbutz Ma'agan Michael (IL); Eyal SHEFFER, Ramat Gan (IL)

(21) Appl. No.: 16/069,626

(22) PCT Filed: Jan. 12, 2017
(86) PCT No.: PCT/IL2017/050042

§ 371 Date: Jul. 12, 2018

Related U.S. Application Data
(60) Provisional application No. 62/277,548, filed on Jan. 12, 2016.

(51) Int. Cl. B01D 39/04; D02G 3/36; D02G 3/44; D02G 3/26; D02G 3/40

(52) U.S. Cl. CPC B01D 39/04; D02G 3/36; D02G 3/447; D02G 3/26; B01D 2239/10; D10B 2505/04; D10B 2331/04; D10B 2401/041; B01D 2239/0216; D02G 3/402

(57) ABSTRACT

A multi-layered yarn, comprising: a central core fiber; an inner fiber wrapped about the central core fiber in an inner helical configuration; and an outer fiber wrapped about the central core fiber and over the inner fiber in an outer helical configuration that is oppositely oriented to the inner helical configuration, to form a protruding cross-hatch pattern having multiple indentations on the surface of the multi-layered yarn, thereby increasing the surface area of the multi-layered yarn.

### CROSS-REFERENCE TO RELATED APPLICATIONS

This application claims priority to U.S. Provisional Patent Application No. 62/277,548, filed Jan. 12, 2016, entitled “Yarn with Multi-Directional Layered Fibers”, the contents of which are incorporated herein by reference in their entirety.

### BACKGROUND

The invention relates to the field of yarns.

Spun yarns are typically formed from multiple twisted continuous or staple fibers to make a cohesive thread. The threads are then combined by plying or twisting them in the opposite direction to the twist of the fibers for added strength.

Monofilament fibers are made of a single fiber, such as nylon, and produced in a variety of thicknesses. The common fishing line is a monofilament fiber.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a multi-layered yarn, comprising: a central core fiber; an inner fiber wrapped about the central core fiber in an inner helical configuration; and an outer fiber wrapped about the central core fiber and over the inner fiber in an outer helical configuration that is oppositely oriented to the inner helical configuration, to form a protruding cross-hatch pattern having multiple indentations on the surface of the multi-layered yarn, thereby increasing the surface area of the multi-layered yarn.

In some embodiments, the central core fiber is a monofilament fiber ranging in thickness between 50 microns (μm) to 150 μm.

In some embodiments, the inner fiber and the outer fiber are spun from multiple monofilament fibers.

In some embodiments, a thread-pitch of the inner helical configuration corresponds to the thickness of the inner fiber and a thread-pitch of the outer helical configuration corresponds to the thickness of the outer fiber.

In some embodiments, a thread-pitch of the inner helical configuration and a thread-pitch of the outer helical configuration correspond to the thickness of the central core fiber.

In some embodiments, any of the outer helical configuration and inner helical configuration have an irregular periodicity such that the cross-hatched pattern is non-uniform and the sizes of the indentations vary.

In some embodiments, the outer helical configuration and inner helical configuration have a substantially regular periodicity such that the cross-hatched pattern is uniform and the sizes of the indentations are substantially regular.

In some embodiments, the thread-pitch of the inner helical configuration is approximately 300 μm and the thread-pitch of the outer helical configuration is approximately 400 μm.

In some embodiments, the thread-pitch of the inner helical configuration is approximately 2-5 times the diameter of the central core fiber and the thread-pitch of the outer helical configuration is approximately 3-6 times the diameter of the central core fiber.

In some embodiments, any of a thread-pitch, angle, thickness and spacing of the inner and outer fibers are selected such that the dimensions of the indentations correspond to a predetermined size.

In some embodiments, at least one of central core fiber, inner fiber, and outer fiber comprises a bicomponent fiber having a fusible outer sheath and a non-fusible inner center, wherein fusible outer sheath has a lower melting point than the non-fusible inner center, thereby allowing the inner fiber and the outer fiber to be melted in place around the central core in the cross-hatch pattern.

In some embodiments, the inner fiber and the outer fiber are melted in place about the central core along the length of the multi-layered yarn, thereby fixating the cross-hatch pattern along the length of the multi-layered yarn and preventing the yarn from unravelling when severed and when subject to a fluid flow pushing against the yarn's severed end.

There is provided, in accordance with an embodiment, a yarn-based fluid-filter, comprising: multiple multi-layered yarns, wherein each multi-layered yarn comprises: a central core fiber; an inner fiber wrapped about the central core fiber in an inner helical configuration; and an outer fiber wrapped about the central core fiber and over the inner fiber in an outer helical configuration that is oppositely oriented to the inner helical configuration, to form a protruding cross-hatch pattern having multiple periodically-spaced indentations on the surface of the multi-layered yarn, thereby increasing the surface area of multi-layered yarn, and thereby decreasing a surface tension formed between the multiple multi-layered yarns.

In some embodiments, a portion of the multiple multi-layered yarns are rotated at an orientation of 180 degrees, and wherein the distribution of the rotated multi-layered yarns within the remaining multi-layered yarns is substantially uniform.

In some embodiments, the multiple multi-layered yarns are oriented such that a fluid introduced into the filter flows along the length of the yarns.

In some embodiments, the decreased surface tension between the multi-layered yarns prevent the multi-layered yarns from crowding of the multi-layered yarns increase the ability of the multi-layered yarns to trap particles, thereby increasing the effectiveness of the yarn-based fluid filter.

In some embodiments, the central core fiber is selected to have a thickness allowing the multiple multi-layered yarns to withstand a force exerted lengthwise thereon.

There is provided, in accordance with an embodiment, a method for producing a multi-layered yarn, comprising: wrapping an inner fiber about a monofilament fiber in an inner helical configuration; wrapping an outer fiber about the monofilament fiber and over the inner fiber in an outer helical configuration that is oppositely oriented to the inner helical configuration, thereby forming an assembled yarn having a cross-hatch pattern with multiple indentations, wherein the thread-pitch of each helical configuration is in the order of the thickness of the central core fiber, and where at least one of the monofilament fiber, the inner fiber and the outer fiber comprises a polymer having a lower melting point the remaining fibers of the multi-layered yarn; heating the assembled yarn until the lower melting point polymer melts sufficiently to fuse the inner and outer fibers over the central core fiber in the cross-hatch pattern while preserving the indentations to produce a fused yarn from the assembled yarn; and cooling the fused yarn.

There is provided, in accordance with an embodiment, a system for producing a multi-layered yarn, comprising: a first bobbin configured to feed an assembled yarn comprising an inner fiber wrapped around a monofilament central core fiber in an inner helical configuration and an outer fiber wrapped around the monofilament central core fiber and over the inner fiber in an outer helical configuration that is oppositely oriented to the first helical configuration; a fusion chamber configured to receive the fed assembled yarn and controllably heat the assembled yarn to produce a fused yarn; a cooling zone configured to cool the fused yarn; a second bobbin configured for winding the fused yarn thereon; and multiple pulleys configured to guide and maintain the tautness of the assembled yarn and the fused yarn between the first bobbin, the fusion chamber, the cooling zone, and the second bobbin.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A shows a simplified illustration of a multi-layered yarn having multiple fibers twisted in opposing directions around a central core;

FIG. 1B shows a simplified illustration of multiple yarns threaded in the same direction;

FIG. 1C shows a simplified illustration of two adjacent yarns of FIG. 1A in a first orientation;

FIG. 1D shows a simplified illustration of two adjacent yarns of FIG. 1A in a second orientation;

FIG. 2 shows a conceptual cross-sectional view of an indentation formed on the surface of the yarn of FIG. 1;

FIG. 3 shows a cross-section of a bi-component fiber having a fusible outer sheath covering a non-fusible center;

FIGS. 4A-B shows a fluid filtration system disposed with multiple yarns of FIG. 1;

FIG. 5 shows a system for fusing the multi-layered yarn of FIG. 1;

FIG. 6 shows a graph of filtration pressure drop in an experimental setup;

FIG. 7 shows a graph of temporal development of filtration pressure drop in the experimental setup;

FIG. 8 shows a graph of turbidity removal over time in the experimental setup; and

FIG. 9 shows a graph of average turbidity values over time of water entering and exiting the filter in the experimental setup.

### DETAILED DESCRIPTION

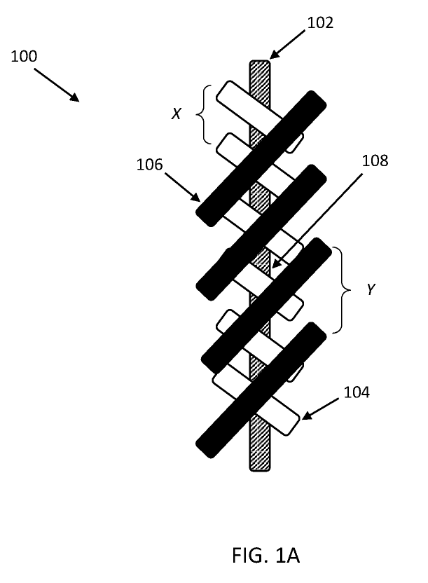

Referring to FIG. 1A, a simplified illustration of a multi-layered yarn 100 is shown having multiple fibers wrapped in opposing directions around a central core. A central core fiber 102 (grey) may be a monofilament fiber ranging in diameter (also “thickness”) between 50 microns (μm) to 200 μm. In one embodiment, central core 102 has a thickness of approximately 100 μm. A second, inner fiber 104 (white) may be wrapped about central core 102 in a helical configuration, and a third, outer fiber 106 (black) may be wrapped about central core 102 and over inner fiber 104 in an oppositely-oriented helical configuration to form a cross-hatch pattern on the surface of yarn 100. The twist of inner fibers 104 and 106 over central core 102 may be either an S-twist or a Z-twist.

In one embodiment, fibers 104 and 106 may each be spun from multiple monofilaments, and may each have a linear density of between approximately 30dtex12f (30 decitex, spun from 12 monofilaments) and 160dtex156f (160 decitex, spun from 156 monofilaments), which corresponds to 27-144 denier; a thickness ranging from 25-120 μm; and have in the order of 500-1500 twist per meter (tpm). Fibers 104 and 106 may have the same density and thickness properties, or alternatively, their density and thickness may differ. Fibers 102, 104, and 106 may be made of the same or different substances, and may be made of any suitable material, such as polyester, polyamide, or polypropylene to name a few. Fibers 104 and/or 106 may have a similar or different thickness than central core 102. In one embodiment, fibers 104 and 106 have a similar thickness to central core 102. In another embodiment, central core 102 is substantially thicker than fibers 104 and 106.

The surface of multi-layered yarn 100 may have a protruding cross-hatch pattern with multiple indentations 108, such as may be diamond-shaped, and formed by fibers 104 and 106 being wound in opposite directions about central core 102, where the depth of indentations 108 is due primarily to the combined thickness of fibers 104 and 106.

In another embodiment, the outer helical configuration and inner helical configuration of fibers 104 and 106 have a substantially regular periodicity such that the cross-hatched pattern is uniform and the sizes of the indentations 108 are substantially regular.

In another embodiment, the helical configurations of any of fibers 104 and 106 along the length of central core 102 may be irregular, resulting in a non-uniform cross-hatch pattern and varying sizes for indentations 108.

Indentations 108 may serve to increase the surface-area of yarn 100 and provide pits, or notches for trapping particles. In one embodiment, multi-layered yarn 100 may be used inside a fluid filtration system, and the thread-pitch, angle, and/or spacing between fibers 104 and 106 together with the thickness of fibers 104 and 106 may be selected such that the dimensions of indentations 108 correspond to the type and/or size of particles that are to be filtered out of the fluid. In one embodiment, the distance between each winding of each of fibers 104 and 106 about central core 102, or their ‘thread-pitch’, may have substantially the same dimension as central core fiber 102. FIG. 1A shows the thread-pitch for inner fiber 104 indicated as X, and the thread-pitch for outer fiber 106, indicated as Y, together defining the size of the opening of indentation 108. In one embodiment, the thread-pitch X of fiber 104 corresponds to the thickness of fiber 104 and the thread-pitch Y of fiber 106 corresponds to the thickness of fiber 106. Alternatively, the thread-pitch X, Y for any of fibers 104 and 106 may be proportional to the thickness of central core 102. In some embodiments, the thread-pitch of fiber 104 may be smaller than the thread-pitch of fiber 106. For example, the thread-pitch X of fiber 104 may be 1.5, 2, 2.5, 3, 3.5, or 4 times the thickness of central core 102, and the thread-pitch Y of fiber 106 may be 2.5, 3, 3.5, 4, 4.5 or 5 times the thickness of central core 102, respectively.

In one embodiment, for a central core 102 having a diameter of approximately 100 μm, the thread-pitch X of inner fiber 104 may range from 250 μm to 350 μm, and the thread-pitch Y of outer fiber 106 may range from 350 μm to 450 μm. In one embodiment, the thread-pitch X of inner fiber 104 is approximately 300 μm, and the thread-pitch Y of outer fiber 106 is approximately 400 μm for a central core diameter of 100 μm. Alternatively, for a central core 102 having a diameter of approximately 50 μm, the thread-pitch X of inner fiber 104 may range from 100 μm to 200 μm, and the thread-pitch Y of outer fiber 106 may range from 150 μm to 250 μm. In one embodiment, the thread-pitch X of inner fiber 104 is approximately 150 μm, and the thread-pitch Y of outer fiber 106 is approximately 200 μm for a central core diameter of 50 μm.

In another embodiment, the thread pitch X, Y of fibers 104 and 106 may be determined as a function of the diameters of any of the cross-section of central core 102, the cross section of fiber 104 and the cross-section of fiber 106. For example,

X=diameter of central core 102*a+diameter of fiber 104*b+diameter of fiber 106*c

where 1<a<6, 1<b<3, 1<c<3;

Y=diameter of central core 102*d+diameter of fiber 104*e+diameter of fiber 106*f

where 1<d<6, 1<e<3, 1<f <3.

Alternatively, the values for a, b, c, d, e, and f may be larger or smaller than described above.

In addition to increasing the surface area of multi-layered yarn 100, the opposing helical configurations of fibers 104 and 106 about central core 102 may reduce a directionality, or directional tendency of yarn 100 to adhere to another adjacent yarn 100, as follows. When yarns and/or fibers are exposed to a fluid, such as air and/or water, surface tension favoring a minimal energy state may cause the yarns to adhere to each other in order to minimize the distance between them.

Referring to FIG. 1B, it can be shown that multiple yarns 126 having the same thread orientation or handedness may be subject to surface tension 120, shown as opposite facing arrows, caused by a fluid that draws the yarns 126 towards each other in accordance with favoring the minimal distance therebetween. It can further be shown that the minimal distance between yarns 126 is achieved when they become interlaced, and wind about each other, manifesting a directionality or directional tendency that results in yarns 126 becoming entangled.

However, the opposing helical-configurations 104 and 106 about central core 102 may reduce the directionality of yarn 100, thereby reducing the tendency of multiple adjacent yarns 100 to interlace and wind about each other, thereby avoiding entanglement when subject to a fluid.

Still, in an embodiment, a yarn with a single thread (which may be spun from multiple monofilaments) wrapped around a central core fiber may be used, as shown in FIG. 1B.

Referring to FIG. 1C two adjacent yarns 100, shown as 100a and 100b, are shown subject to surface tension 122 drawing them together. Outer fibers 106a and 106b of adjacent yarns 100a and 100b pose a barrier separating inner fibers 104a and 104b having similarly oriented, or same-handed threads, to reduce the surface tension between inner fibers 104a and 104b. Additionally, the opposing orientation, or opposing-handedness of the threads of inner fibers 104a and 104b with respect to the threads of outer fibers 106a and 106b may reduce surface tension between adjacent outer fibers 106a and 106b, resulting in overall reduced surface tension 122 between yarns 100a and 100b, shown as smaller arrows than surface tension 120.

Referring to FIG. 1D, two adjacent yarns 100a and 100b are shown subject to surface tension 124 drawing them together. Yarns 100a and 100b are vertically oriented at 180° degrees to each other ensuring opposite thread orientation, or opposite thread-handedness, between outer fibers 106a and 106b, further reducing directionality between adjacent yarns 100a and 100b resulting in an even lower surface tension 124. Positioning yarns 100a and 100b thus, any two adjacent helical configurations of any of inner fibers 104a and 104b and outer fibers 106a and 106b are oppositely oriented, which may serve to reduce overall surface tension and directionality between yarns 100a and 100b.

The thickness of inner and outer fibers 104a, 104b, 106a, and 106b may affect the surface tension between yarns 100a and 100b and may be selected accordingly, such as using the formulae above. The resulting reduction in directionality for any given yarn 100 achieved by the contra-directional winding of fibers 104 and 106 about central core 102 may serve to reduce clumping or crowding of multiple yarns 100 positioned within a dynamic fluid flow due to the reduced surface tension between the yarns 100. Positioning a bundle of multiple yarns 100 configured thus to prevent crowding of the yarns 100 within a fluid filter may preserve the individual exposure of each yarn 100 to the fluid flowing therein, and maintain the effective surface area of the yarns 100 during the filtration and/or rinsing process, increasing their effectiveness to trap particles immersed in the fluid.

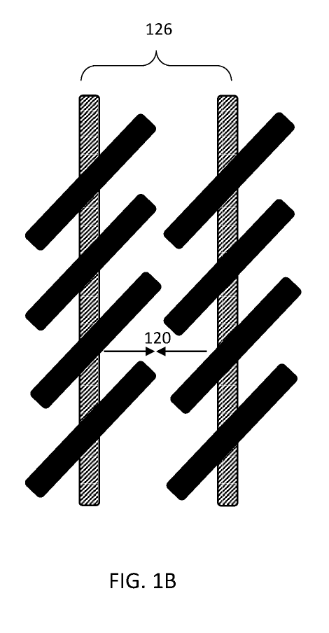

Referring to FIG. 2, a conceptual cross-sectional view of indentation 108 formed on the surface of yarn 100 is shown, having a depth Z corresponding to the combined thicknesses of fibers 104 and 106. The cross-section of fibers 104 and 106 is shown elliptical relative to the circular cross-section of central core fiber 102 due to their respective orientation.

The stiffness of yarn 100 with respect to bending and/and twisting may be substantially attributable to central core fiber 102. The stiffness quality may be characterized by the moment of inertia of yarn 100, and which is proportional to the thickness, or cross-section of central core fiber 102. For a central core fiber 102 having a circular cross-section, the moment of inertia I may be expressed as a function of the diameter d of the central core's cross-section, raised to the power four, or d⁴. Thus, central core fiber 102 may be selected in accordance with its moment of inertia to provide a desired stiffness for yarn 100. It may be noted that any of yarn 100, central core fiber 102, and fibers 104 and 106 may have any suitable cross-section such as round, oval, square, rectangular, X-shaped, star-shaped, hexagon-shaped, or other.

For example, for a central core having a circular cross-section, I may be approximated as d⁴/20. Thus, for a 0.2 millimeter (mm) diameter round fiber, the moment of inertia for the yarn I is 0.00008 mm⁴, for a 2 mm diameter fiber the moment of inertia for the yarn I is 0.8 mm⁴, for a 50 μm diameter fiber the moment of inertia I for the yarn is 312,500 μm⁴.

In one embodiment, the moment of inertia of yarn 100 may correspond to the moment of inertia of a round fiber having a diameter ranging from 20 μm to 200 μm. Alternatively, the moment of inertia of yarn 100 may range from 8000 μm⁴ to 80×10⁶ μm⁴.

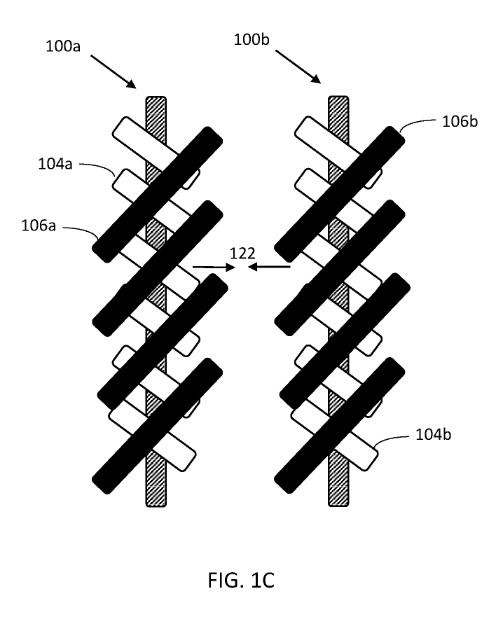

Reference is now made to FIG. 3 which shows a cross-section of a bi-component fiber having a fusible outer sheath covering a non-fusible center. At least one of fibers 104, 106 and 102 may be a bi-component fiber, having a fusible outer coating or sheath 110 covering a non-fusible center 112, where sheath 110 has a lower melting point than center 112 and the other, uncoated fibers. In one embodiment, fibers 104 and/or 106 are provided with fusible outer coating 110 having a lower melting point than central core 102, allowing fibers 104 and 106 to be melted in place around central core 102 in the cross-hatch pattern shown in FIG. 1.

Additionally or alternatively, central core fiber 102 may be provided with fusible sheath 110 covering a non-fusible center 112. Applying heat to yarn 100 configured thus may cause fusible sheath 110 and optionally any of fusible fibers 104 and 106 or their fusible outer-coatings to melt, thereby fixating fibers 104 and 106 about central core 102 in the cross-hatch pattern.

Fibers 104 and 106 may be melted in place about central core 102 to fixate their cross-hatch pattern along the length of yarn 100, to prevent yarn 100 from unravelling when severed and/or when subject to a fluid flow pushing against the severed end of yarn 100.

In one embodiment, mono-filament central core 102 may be substantially thicker than fibers 104 and 106 such that the width of mono-filament central core 102 contributes significantly to the total width of yarn 100, resulting in yarn 100 being substantially stiff. This property may be beneficial when using yarn 100 in a lengthwise orientation within a fluid filtration system subjecting yarn 100 to a fluid force tending to bend and/or twist yarn 100. In such a system, the stiffness of yarn 100 may prevent entanglement, bending or sideways movement of yarn 100, and which may preserve the effective surface area with respect to the filtration and/or cleaning fluid. In one embodiment, the thickness of mono-filament central core 102 may be selected in accordance with a desired stiffness attribute of yarn 100 that allows yarn 100 to withstand the fluid force exerted on yarn 100 and prevent yarn 100 from any of bending, buckling, swaying, and twisting. For example monofilament central core 102 may be selected to have a thickness that is between 1 and 2, 2 and 3, 3 and 4, 4 and 5, 5 and 6, 6 and 7, 7 and 8, 8 and 9, or 9 and 10 times as thick as any of fibers 104 and 106.

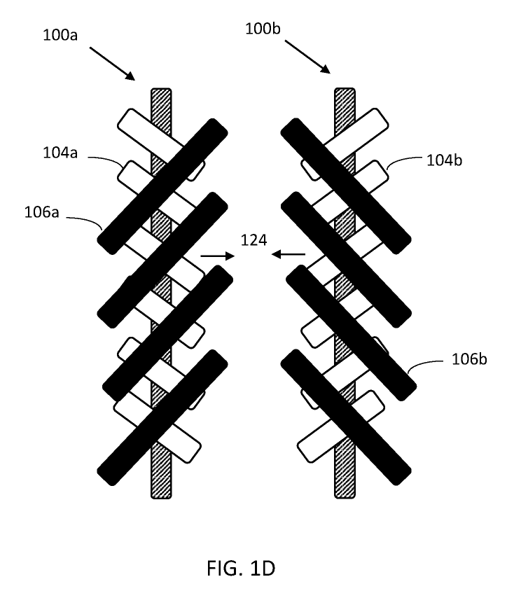

Reference is now made to FIGS. 4A-B, which show two configurations for a sheaf-based fluid filter disposed with multiple yarns of FIG. 1. This filter is optionally identical or similar to the sheaf-based fluid filter disclosed in PCT Publication No. WO2015/033348, “Sheaf-Based Fluid Filter”, which is incorporated herein by reference in its entirety, with the notable differences that the “threads” of the '348 publication are the “yarns” of the present disclosure.

Referring to FIG. 4A, in one embodiment, a bundle (or “sheaf”) 118 of multiple yarns 100 may be positioned within a fluid filtration system 120 having an inlet 122 and an outlet 124. Optionally, a portion of the multiple yarns 100 are rotated at a 180 degree orientation, or ‘up-side-down’ to the remaining yarns 100 in the bundle, indicated as arrows on yarns 100, where the arrows are intended for illustrative purposes only and are understood to indicate the direction of the twisting of fibers 104 and 106 about central core 102. For example, downwards-pointing yarns 100a may have outer fiber 106 twisted in a clockwise direction about core 102 and inner fiber 104 twisted in a counter-clockwise direction about core 102, whereas upwards-pointing yarns 100b may have outer fiber 106 twisted in a counter-clockwise direction about core 102 and inner fiber 104 twisted in a clockwise direction about core 102. Optionally, the distribution of the downwards-pointing to the upwards-pointing yarns may be substantially uniform to further reduce any directional tendencies of any individual yarns 100 within bundle 118, and further reduce a likelihood of that any of the multiple yarns 100 will stick or clump together when wet. FIG. 4B is substantially similar to that of FIG. 4A with the notable difference that yarns 100 are oriented in the same direction.

It may be noted that the substantial stiffness, relatively large surface area, and relatively low directional tendency of threads 100 when used as a filtration medium within filter 120 may increase the effectiveness of filter 120. In particular, the relative stiffness and lack of directional tendencies of threads 100 may increase the effectiveness of filter 120 during a rinse cycle that subjects threads 100 to a cleaning fluid flowing along their lengths from their attached ends to their free ends by preventing threads 100 from sticking and/or crowding together, thereby allowing any trapped particles to be released. Similarly, the relative stiffness and large surface area of threads 100 may increase the effectiveness of filter 120 during a filtration cycle that subjects threads 100 to a filtration fluid flowing along their lengths from their free ends to their attached ends by preventing threads 100 from sticking and/or crowding, thereby maintaining their relatively large surface area with respect to the filtration fluid allowing particles to be trapped therein.

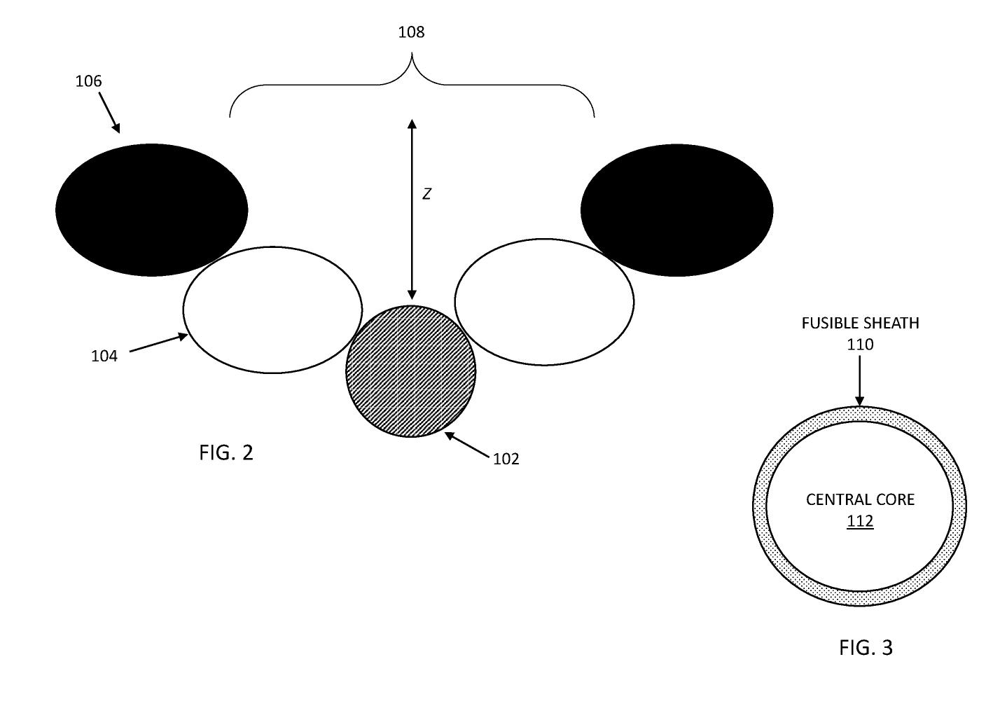

Reference is now made to FIG. 5 which shows a conceptual illustration of a system for fusing inner and outer fibers 104 and 106 about monofilament fiber 102, in accordance with an embodiment. Monofilament central core fiber 102 may be wrapped by fibers 104 and 106 in two opposite-facing helical configurations forming the cross-hatch pattern with multiple indentations as described above, to produce an assembled yarn 100a. The thread-pitch of each helix may be in the order of the thickness of central core fiber 102, and at least one fiber of assembled yarn 100a may be made using a polymer having a lower melting point the remaining fibers of yarn 100a. Assembled yarn 100a may be wrapped around a first bobbin 530, allowing yarn 100a to be controllably unwound and fed into a fusion chamber 532.

Fusion chamber 532 may controllably heat the segments of yarn 100a fed therethrough, where the velocity at which yarn 100a is unwound from bobbin 530, the length of fusion chamber 532 and the intensity of the heat radiated by fusion chamber 532 are selected to allow any fusible elements of yarn 100a to melt sufficiently to fixate the cross-hatch pattern formed by fibers 104 and 106 along the length of central core 102 and produce fused yarn 100. Fusion chamber 532 may heat yarn 100a until the lower melting point polymer melts sufficiently to become tacky and fuse assembled yarn 100a in the cross-hatch pattern while maintaining the indentations described above, to produce fused yarn 100. Fused yarn 100 may be cooled by guiding fused yarn 100 through a cooling zone 534. The cooled fused yarn 100 may be wound about a bobbin 538. One or more pulleys 536 may be provided to guide and maintain tautness of assembled yarn 100a and fused yarn 100 between bobbins 530, 538, fusion chamber 532, and cooling zone 534.

The environment within fusion chamber 532 and cooling zone 534 may be controlled in a manner to protect assembled yarn 100a and fused yarn 100 during the thermal treatment. For example, any of atmospheric air, CO₂, water vapor, Nitrogen or any other suitable gas may be introduced into any of fusion chamber 532 and/or cooling zone 534 during the fusing process.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicated number and a second indicated number and “ranging/ranges from” a first indicated number “to” a second indicated number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies or a disagreement between this application and any document incorporated by reference, it is hereby intended that the present application controls.

### Experimental Results

A series of sixteen consecutive water filtration cycles were conducted using a sheaf-based fluid filtration system, as the one discussed in relation to FIG. 4A above. A washing cycle followed each filtration cycle. Tap water spiked with ISO 12103-1 Arizona Test Dust Contaminants A4 (Powder Technology, Inc., USA) was used.

The sheaf-based fluid filtration system included a cylindrical sheaf with a diameter of 80 millimeters, containing 95,000 bundled yarns. Each of the yarns had a bi-component central core, made of a poly(ethylene terephthalate) fiber coated with a fusible outer sheaf. The central core had a 100 μm average diameter. Two 78dtex77fPET fibers were helically wrapped, with an S-twist, around the central core, at 1000 tpm. The overall average diameter of each yarn was 230±23 μm.

Tables 1, 2, and 3 summarize the results of the experiment, averaging the counts of the 16 filtration cycles. Counts were made by the LS-20 Liquid Sampler by Lighthouse Worldwide Solutions, USA. Table 1 shows a particle count of differently-sized particles entering the filter, and Table 2 shows a particle count of differently-sized particles exiting the filter. Table 3 shows the percentage of particles successfully removed by the filter, by particle size.

TABLE 1

| | Particle size (μm) | | | | | | | |
|---|---|---|---|---|---|---|---|---|
| | 1 | 2 | 3 | 5 | 7 | 10 | 12 | 20 |
| | Particle count - in | | | | | | | |
| Average | 74,087 | 30,940 | 16,098 | 9,110 | 5,459 | 1,515 | 398 | 43 |

TABLE 2

| | Particle size (μm) | | | | | | | |
|---|---|---|---|---|---|---|---|---|
| | 1 | 2 | 3 | 5 | 7 | 10 | 12 | 20 |
| | Particle count - out | | | | | | | |
| Average | 7,840 | 3,186 | 1,593 | 841 | 464 | 92 | 13 | 0.3 |

TABLE 3

| | Particle size (μm) | | | | | | | |
|---|---|---|---|---|---|---|---|---|
| | 1 | 2 | 3 | 5 | 7 | 10 | 12 | 20 |
| | Particle count - removal | | | | | | | |
| Average | 90.0% | 89.5% | 89.3% | 89.6% | 90.2% | 93.0% | 96.4% | 99.1% |
| STDEV | 2% | 1% | 2% | 3% | 4% | 4% | 2% | 1% |
| CV | 2% | 1% | 2% | 4% | 4% | 4% | 2% | 1% |
| 2•standard | 2% | 1% | 3% | 5% | 6% | 6% | 3% | 1% |
| error | | | | | | | | |

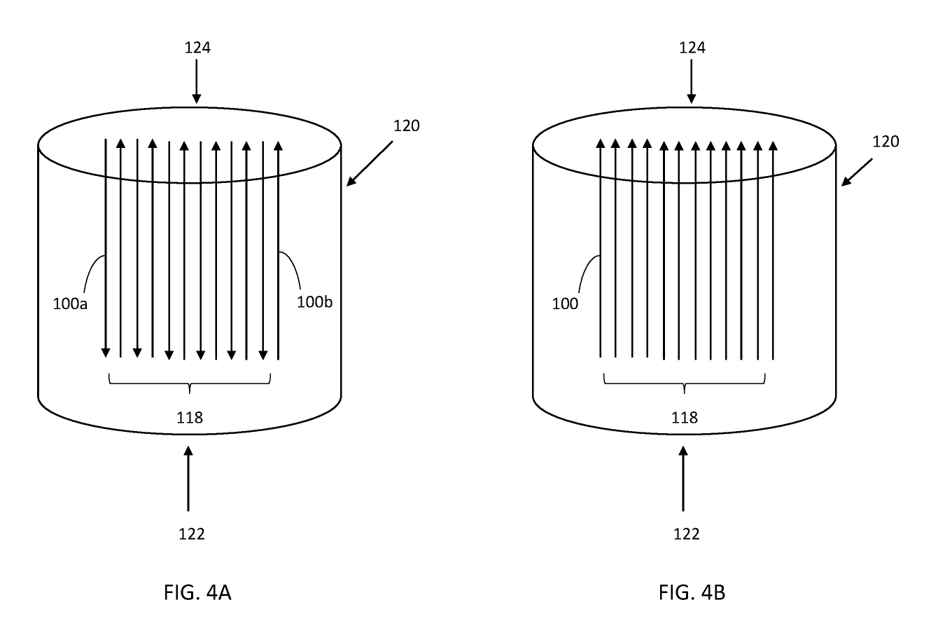

FIG. 6 shows a graph of filtration pressure drop at the beginning of each of the 16 filtration cycles. As shown, the pressure drop (AP) remained around 0.13-0.15 bar along all cycles.

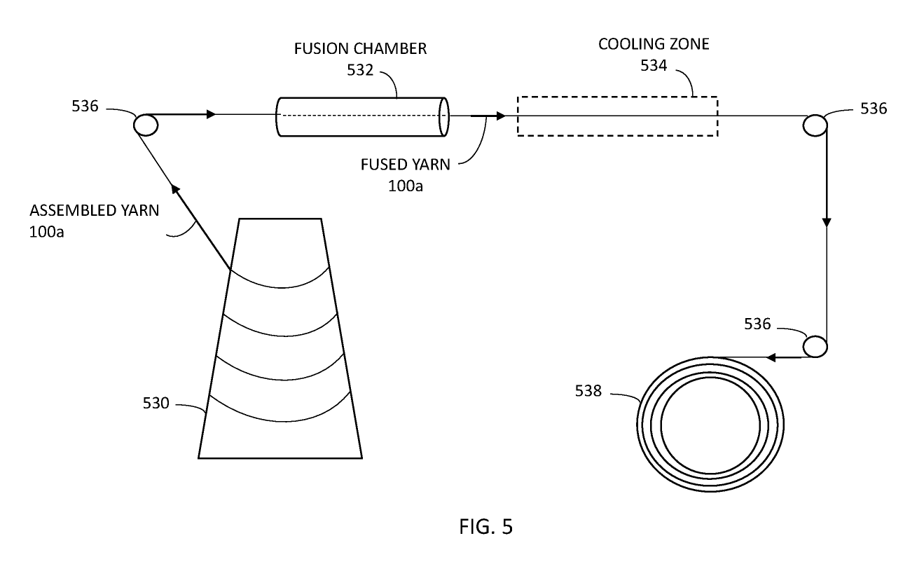

FIG. 7 shows a graph of temporal development of the filtration pressure drop, averaged across all 16 filtration cycles. Each of the filtration cycles was 180 minutes long, and the pressure drop only slightly increased from about 0.14 bar to about 0.18 bar along the 180 minutes of a cycle. This indicates that the advantageous filtration results shown in Table 3 above can be acquired while maintaining an acceptable pressure drop along each filtration cycle. In addition, this demonstrates, on one hand, the stability of the yarn endowed by the rigid core, but on the other hand, the excellent filtration properties due to the twisted spun fibers which give the yarn an extensive surface area.

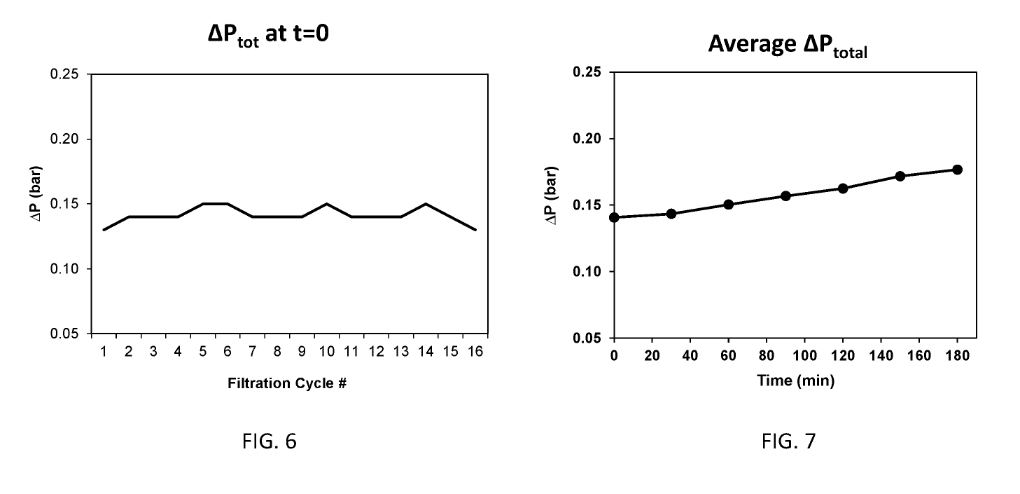

FIG. 8 shows a graph of turbidity (denoted in NTU) removal rates along the 180 minutes of an average cycle. An excellent rate of 93±0.3% (average ±2·SEM) was maintained throughout the entire cycle.

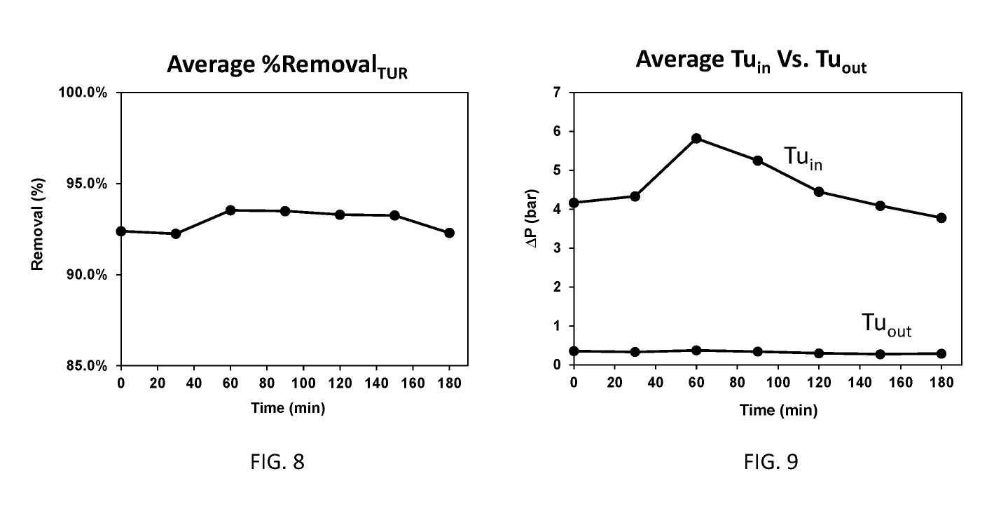

FIG. 9 shows a graph of average turbidity values (denoted in NTU) along the 180 minutes of an average cycle, as measured when entering the filter (Tuₘ) and exiting it (Tuₒᵤₜ). While the turbidity varied greatly in the stream entering the filter (between 3.8 and 5.7 NTU on average across 16 cycles, with peaks as high as 10 NTU), the filter succeeded in consistently outputting low-NTU water, of about 0.32±0.03 NTU, along the entire duration of the cycle.

1. A multi-layered yarn, comprising:
a central core fiber;
an inner fiber wrapped about the central core fiber in an inner helical configuration; and
an outer fiber wrapped about the central core fiber and over the inner fiber in an outer helical configuration that is oppositely oriented with respect to the inner helical configuration, to form a protruding cross-hatch pattern having multiple indentations on the surface of the multi-layered yarn.

2. The multi-layered yarn of claim 1, wherein the central core fiber is a monofilament fiber ranging in thickness between 50 microns (μm) and 150 μm.

3. The multi-layered yarn of claim 1, wherein the inner fiber and the outer fiber are spun from multiple monofilament fibers.

4. The multi-layered yarn of claim 1, wherein a thread-pitch of the inner helical configuration corresponds to the thickness of the inner fiber and a thread-pitch of the outer helical configuration corresponds to the thickness of the outer fiber.

5. The multi-layered yarn of claim 1, wherein a thread-pitch of the inner helical configuration and a thread-pitch of the outer helical configuration correspond to the thickness of the central core fiber.

6. The multi-layered yarn of claim 1, wherein any of the outer helical configuration and inner helical configuration have an irregular periodicity such that the cross-hatched pattern is non-uniform and the sizes of the indentations vary.

7. The multi-layered yarn of claim 1, wherein the outer helical configuration and inner helical configuration have a substantially regular periodicity such that the cross-hatched pattern is uniform and the sizes of the indentations are substantially regular.

8. The multi-layered yarn of claim 1, wherein the thread-pitch of the inner helical configuration is approximately 300 μm and the thread-pitch of the outer helical configuration is approximately 400 μm.

9. The multi-layered yarn of claim 1, wherein any of a thread-pitch, angle, thickness and spacing of the inner and outer fibers are selected such that the dimensions of the indentations correspond to a predetermined size.

10. The multi-layered yarn of claim 1, wherein at least one of the central core fiber, the inner fiber, and the outer fiber comprises a bicomponent fiber having a fusible outer sheath and a non-fusible inner center, wherein the fusible outer sheath has a lower melting point than the non-fusible inner center, thereby allowing the inner fiber and the outer fiber to be melted in place around the central core in the cross-hatch pattern.

11. The multi-layered yarn of claim 10, wherein the inner fiber and the outer fiber are melted in place about the central core along the length of the multi-layered yarn, thereby fixating the cross-hatch pattern along the length of the multi-layered yarn and preventing the yarn from unravelling when severed and when subject to a fluid flow pushing against the yarn's severed end.

12. A yarn-based fluid-filter, comprising:
multiple multi-layered yarns, wherein each multi-layered yarn comprises:
a central core fiber;
an inner fiber wrapped about the central core fiber in an inner helical configuration; and
an outer fiber wrapped about the central core fiber and over the inner fiber in an outer helical configuration that is oppositely oriented to the inner helical configuration, to form a protruding cross-hatch pattern having multiple periodically-spaced indentations on the surface of the multi-layered yarn,
and thereby decreasing a surface tension formed between the multiple multi-layered yarns.

13. The yarn-based fluid-filter of claim 12, wherein a portion of the multiple multi-layered yarns are rotated at an orientation of 180 degrees, and wherein the distribution of the rotated multi-layered yarns within the remaining multi-layered yarns is substantially uniform.

14. The yarn-based fluid filter of claim 13, wherein the multiple multi-layered yarns are oriented such that a fluid introduced into the filter flows along the length of the yarns.

15. The yarn-based fluid filter of claim 14, wherein the decreased surface tension between the multi-layered yarns prevent the multi-layered yarns from crowding and the increased surface area of the multi-layered yarns increase the ability of the multi-layered yarns to trap particles, thereby increasing the effectiveness of the yarn-based fluid filter.

16. The yarn-based fluid filter of claim 14, wherein the central core fiber is selected to have a thickness allowing the multiple multi-layered yarns to withstand a force exerted lengthwise thereon.

17. A method for producing a multi-layered yarn, comprising:
wrapping an inner fiber about a monofilament fiber in an inner helical configuration;
wrapping an outer fiber about the monofilament fiber and over the inner fiber in an outer helical configuration that is oppositely oriented to the inner helical configuration, thereby forming an assembled yarn having a cross-hatch pattern with multiple indentations,
wherein the thread-pitch of each helical configuration is in the order of the thickness of the central core fiber, and where at least one of the monofilament fiber, the inner fiber and the outer fiber comprises a polymer having a lower melting point the remaining fibers of the multi-layered yarn;
heating the assembled yarn until the lower melting point polymer melts sufficiently to fuse the inner and outer fibers over the central core fiber in the cross-hatch pattern while preserving the indentations to produce a fused yarn from the assembled yarn; and
cooling the fused yarn.

18. (canceled)
